(19) United States
(12) Patent Application Publication
(10) Pub. No.: US 2011/0251914 A1
(43) Pub. Date: Oct. 13, 2011

(54) System and Method for Providing Scalable and Customized Product Offerings to Customers

(75) Inventor: Holden Caine, Boulder, CO (US)

(73) Assignee: Fujifilm North America Corporation

(21) Appl. No.: 13/119,327

(22) PCT Filed: Sep. 22, 2009
(86) PCT No.: PCT/US09/57872

§ 371 Date: Jun. 10, 2011

Related U.S. Application Data
(60) Provisional application No. 61/098,968, filed on Sep. 22, 2008.

(51) Int. Cl. G06Q 30/00

(52) U.S. Cl. 705/26.1

(57) ABSTRACT

The present invention is directed to a data driven methodology to construct software configurations and product catalogs. A system and method are provided for tracking and maintaining large numbers of groupings of data and their interrelationships and thereby providing scalable and customized product offerings to customers. In particular, the present invention relates to a product catalog tagging methodology for specifying and making available specific product items from a catalog of products, to individual customers or locations. Such product offering of related data items include, product availability information, product descriptions and graphics, associated pricing, shipping/delivery options, product specifications (e.g., image sizes in the case of a photography related implementations), mappings of orderable products to fulfillment instructions, and specifications for centralized/common data files that may be relevant to particular fulfillment locales.

### CROSS-REFERENCE TO RELATED APPLICATIONS

This application claims the benefit of U.S. Patent Application No. 61/098,968, filed Sep. 22, 2008.

### FIELD OF THE INVENTION

The present invention generally relates to a system and method for tracking and maintaining large numbers of groupings of data and their interrelationships and thereby providing scalable and customized product offerings to customers. In particular, the present invention relates to a product catalog tagging methodology for specifying and making available specific product items from a catalog of products, to individual customers or locations.

### BACKGROUND OF THE INVENTION

The ability to transmit, store, update, and consume product catalog data is at the forefront of the requirements for many industries today. Solutions to provide scalable, manageable, and robust order placement, delivery, and fulfillment, constantly plague various companies. Intrinsic to these environments is the vast amounts of data, the variations in the sources of such data, and the myriad of delivery locations where the data would be utilized. For example, there exists a need to provide a methodology that can be utilized to describe product offerings and pricing, delivery options, and, in the cases where the ordering facility is also a production facility, the instructions for producing the order.

The wide spread use of computing devices and application programs creates avenues for developers and applications to address data consolidation, data collation, and data migration requirements by providing systems or tools that may be utilized to facilitate end user requirements. Such a tool or system is one that addresses product catalog requirements. A resulting system would ideally be utilized as an end-product or be integrated into existing or newly developed systems. Existing tools tend to be limited in the ability to handle multiple product offerings and do not offer a scalable solution that can be widely deployed. As such, there is a need for significant improvement in such systems and tools.

What is needed is one or more tool that will facilitate and enable the ability to, in one aspect, define product availability at vendor and store levels and, in another aspect, provide a representation of the product offerings for use in application programs. The features of the tool when applied to application development would enable applications to have enough information to send well-formed orders to various ordering and fulfillment destinations or systems.

One area in which such a tool might be beneficial is in digital photo image processing. Digital photo image processing is a rapidly growing technology area. Digital cameras are in wide use today and a user has many options as to how the digital images are converted to a photograph. For example, users may simply download images from a digital camera to a computing device for direct printing or to a personal computer where the user may edit or otherwise modify the image as desired. Another currently available option is to physically deliver or send the digital images electronically to a photofinisher or Kiosk that will print and mail the desired photos or imprint the images onto other products for the user. Yet another option enables an end user to send electronic digital images to fulfillment centers that can provide imprinting services of the images onto other goods such as, greeting cards, mugs, baseball caps, bags, and a variety of other items.

Fulfillment centers are not created equal. In other words, different fulfillment centers typically have different configurations, i.e., equipment, pricing, shipping options and product requirements, among other things. Each fulfillment center is constrained by its configuration to providing a limited number of functions or services. However, a vendor or other purveyor of image related products and processing equipment that supplies or otherwise handles orders for these varied fulfillment centers, would likely have a product offering that far exceeds the capabilities of any one fulfillment center. This mismatch creates problems for such vendors and other providers who have an interest in offering a complete array of products to their end users. Heretofore, this mismatch has been handled in a relatively unsophisticated and cumbersome manner. One such method involves providing to each fulfillment center, a base list of products from which the center may indicate the types of orders that they can fulfill, whereupon the vendor then configures the end user application or order placement system accordingly. The configuration of the end user application or order placement system usually involves software code that needs to be compiled for each environment and subsequently tracked for maintenance or upgrade purposes. Furthermore, when there is a change in any of the related configurations, the process of product identification and end user application recompilation, as well as other tasks, need to be repeated and are prone to errors. This inefficient, ad hoc and error prone approach creates a burden for the vendor and the fulfillment centers. As the complexity of the fulfillment center offerings increases, so do the adverse effects. There is currently no efficient technique for conveying individualized product offerings, let alone adapting the order placement system in response to changes in such offerings.

Accordingly there is a need for an efficient, scalable, user friendly and robust technique for providing targeted product offerings to customers relative to capabilities and offering of fulfillment and order centers.

The present invention fills these needs as well as other needs.

### SUMMARY OF THE INVENTION

In order to overcome the above stated problems, the present invention provides a tool and technique for the collection of informational data items from multiple sources for use in describing a variety of product offerings referred to herein as a product catalog. Such product offerings of related data items include, product availability information, product descriptions and graphics, associated pricing, shipping/delivery options, product specifications (e.g., image sizes in the case of a photography related implementations), mappings of orderable products to fulfillment instructions, and specifications for centralized/common data files that may be relevant to particular fulfillment locales. The present invention also enables the product catalog to be integrated into vendor and third party application programs in a manner that allows for the placing of well-formed orders to fulfillment centers.

In one aspect, the present invention includes a method for providing one or more product offerings on a target system. The method comprises: applying grouping criterion to one or more assets to define a first tag having one or more content items, wherein each asset is a version or reference to a data file; utilizing the first tag to subsequently define and describe a second tag, wherein the second tag inherits the one or more content items from the first tag, the second tag being defined to include one or more additional content items including assets, grouping criteria and version; providing a hierarchical relationship between the first and second tags, whereby the second tag operates to modify or remove one or more content items inherited from the first tag; and defining a catalog item utilizing the first and/or second tag, wherein the catalog item is mapped to the one or more product offerings on the target system.

In another aspect, the present invention includes a computing system for managing a plurality of data files and the interrelationship among the plurality of data files in a business enterprise deployment of an application or product, the computing system having executable instructions and data structures. The system includes a hierarchical data model for specifying the configuration of the application or product as a grouping of one or more tags. The one or more tags comprise one or more assets each providing a reference to the data files, a grouping criteria for providing common properties among the assets, and a tag version, wherein the one or more tags is a binding of the one or more assets defined by the grouping criteria. The tag version is a reference to a particular representation in time of the one or more assets and the grouping criteria. The one or more tags are associated with organizational units in the business enterprise, wherein the hierarchical data model is resolved to determine each of the plurality of data files to be included in the enterprise deployment.

In a further aspect, the present invention provides a method programmed in a computing environment for providing packaging, tracking and maintenance of a logical grouping of system files for distribution to organizational units within an enterprise. The method comprises: identifying each of the system files as assets; providing a grouping criterion of common properties among the assets; providing a tag, wherein the tag is a binding of the assets by the grouping criterion; providing a version designation for the tag to refer to a snapshot of the state of the assets associated with the tag at a certain point in time; providing a hierarchical data model for specifying the configuration of the distribution as a grouping of two or more of the tag; and associating the tag with organizational units within the enterprise, wherein resolution of the hierarchical data model identifies each system file that is to be included in the enterprise distribution for each of the organizational units.

Additional benefits of the above described system and method for providing localized user interface screens are set forth in the following discussion.

### BRIEF DESCRIPTION OF THE DRAWINGS

The above-mentioned and other features and advantages of this invention, and the manner of attaining them, will become apparent and be better understood by reference to the following description of the invention in conjunction with the accompanying drawing, wherein:

FIG. 1 generally illustrates a networking environment in which the present invention may be implemented;

FIG. 2 is a block diagram generally illustrating an overview of an exemplary embodiment of the present invention and components thereof;

FIG. 3A is a block diagram generally illustrating the hierarchical structure of an aspect of the implementation of a central configuration system shown in the embodiment of FIG. 2;

FIG. 3B is a block diagram generally illustrating a node included in the hierarchical structure shown in FIG. 3A;

FIG. 4 is block diagram illustration of an example of the application of the present invention to a photo processing implementation; and

FIG. 5 is a block diagram generally illustrating a computing environment in which the invention may be implemented.

### DETAILED DESCRIPTION OF THE INVENTION

Generally, the tools and methods described herein for creating and implementing asset configuration, management and tracking for providing customized product offering may be implemented in hardware, software or a combination thereof.

This document is organized as follows. In the first section, an overview of the techniques and implementation is provided and described. In the next section, an exemplary system in which the present invention would be applicable, specifically a photo ordering process is discussed. Following this, the specifics of the implementation for the photo ordering process is discussed, including data structures and the organization of same, along with the operational function of the present invention. Finally, an exemplary computer environment for the implementation and use of the invention is described.

### Overview of Techniques and Implementations

The present invention provides a system and method for enabling enterprises to track and maintain large numbers of groupings of data items and their interrelationships and, in so doing, enhance the ability to provide software distribution and product offering distributions.

The present invention introduces a number of concepts and a unique paradigm for the grouping and utilization of information. Certain key terms need to be addressed and understood in order to appreciate the invention. The present invention is described with reference to equipment and processes relating to photography and more specifically, the photo ordering and fulfillment process. However, as would be appreciated by one skilled in the art, the invention is applicable to other processes and implementations, the references and discussion provided herein are strictly for illustrative purposes and are not intended to limit the scope of the invention.

A product tag or tag as used herein, is a unit of reference and distribution for file groupings utilized for constructing software configurations and product catalogs. Thus, a software configuration or product catalog is defined as a grouping of one or more tags.

A Tag in this context is defined as a binding of assets governed by one or more grouping criteria. A Tag may also be versioned, meaning that the set of assets associated with the Tag and/or the grouping criteria may change over time, but each change is tracked, and any revision of a Tag would be reproducible upon request.

An asset can be defined as a specific version of a data file, or a reference to a data file, such as a URI (Universal Resource Identifier). A Grouping Criterion can be defined as a common property found among assets, such as the manufacturer or model of a certain printer or other tool including software programs, that pertain to the assets.

A version of a tag refers to a snapshot of the state of the assets associated with the tag and the grouping criteria set of the tag at a certain point in time. A version number or unique text string would be used to denote such a snapshot for future reference.

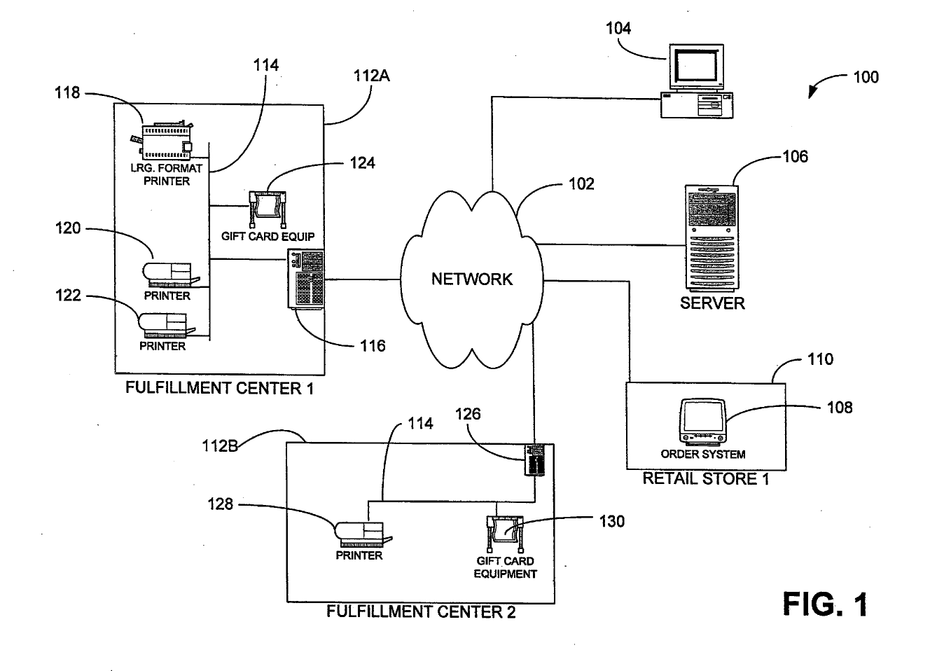

Having described some base concepts of the invention, aspects of the invention will now be described with reference to the drawing figures. An exemplary environment or system to which the present invention would be applicable is shown in FIG. 1 and is designated as reference numeral 100.

The environment 100 may include a network 102, such as a Local Area Network (LAN), Wide Area Network (WAN), Wireless network or other similar configuration for allowing communication among two or more computing devices. Connected to the network 102 may be a general purpose computing device 104. Computing device 104 includes devices such as handheld devices, laptop computers or personal computers, which may be located in a home, office, retail location or other environment, and that provide an interface for user interaction with local or remote applications or systems. Computing device 104 may be a wireless device such as a cellular phone or personal digital assistant. A server 106 may also be connected to the network 102 to provide any one or more of a variety of functions including serving as a web server, data store, and application server and/or provide other services. An order device 108, located at a retail store 110 may also be connected to the network. One or more fulfillment centers 112A, 112B may also be remotely located and connected to the network 102. Each fulfillment center 112A, 112B, may have its own local area network 114 and a local server 116, 126 in addition to other devices for fulfilling user orders. The server 116, may provide local services in addition to providing communication and data exchange with network server 106. In addition to typical devices found in any office environment, the fulfillment center 112A may include a large photo format printer 118, printers 120, 122, and a gift card printing machine 124. Similarly, yet distinctively, fulfillment center 112B may include a local server 126, a printer 128, and a gift card printing machine 130.

Generally, the present invention relates to providing to a user of the computing devices 104, or a user of the ordering device 108, an offering of products from the either one or both fulfillment centers 112A, 112B. An example of such a use might be to enable the user, using remote computing device 104 to order a print of at least one digitally represented image from one of the fulfillment centers 112A, 112B. An end user may provide a data file or other representation of a digitally represented image, select a print format for the digitally represented image, establish a print order that includes a print format, and optionally save the print order on the computing device 104 or a type of removable memory storage or media (e.g., CD, floppy disk, flash drive, etc.). The print order data file may be uploaded or otherwise communicated to at least one of fulfillment centers 112A, 112B via the network 102, or by otherwise providing media that contains the order to the fulfillment centers 112A, 112B. Thereafter, the at least one fulfillment center 112A, 112B processes and delivers the print of the digitally represented image or other products, to the user or a third-party designated by the user in accordance with the user defined delivery criteria.

In order to provide product offerings to the user such that an order can be placed with the fulfillment centers 112A, 112B, one or more software programs, typically working in concert with the interface to the user, must have a “knowledge” of amongst other things: the relevant fulfillment center(s); the options/equipment available at each center; the pricing information at the centers; promotions if any; and any business rules for the different centers. As such, designers of the end user applications, system wide business logic, and fulfillment center systems/applications, would have to ensure the collaboration of all these systems and the coordination of the informational items for these systems, as well as deal with issues relating to the impact of any changes or upgrades of existing systems, or the addition of new equipment/products at any of the fulfillment centers 112A, 112B. The present invention provides means for designers and means for application programs to acquire and utilize this “knowledge” of the various informational items and their interrelationships. More specifically, the present invention provides a methodology for tagging products, otherwise referred to as a product catalog.

A product catalog is a grouping of tags that describe, in the exemplary embodiment of the present invention, the product offerings, their pricing, delivery options, and, in the cases that the ordering facility is also a production facility, the instructions for producing the order. Tags represent a unitary reference to components that describe particular aspects or properties of the specific items within the catalog.

### Exemplary System

A discussion of an exemplary application will further highlight some of the salient features of the invention. The exemplary application relates to a photo ordering process, a product catalog may be a number of eXtensible Markup Language (XML) files, that contain all the information used to:

Define product availability at vendor and store levels;

Represent a product in an application including:
Descriptions;
Product graphics; and
Product categorization;

Define product shipping options;

Define vendor and store-specific pricing;

Define per product image size requirements;

Define mappings of orderable products to fulfillment instructions; and

Provide the definition of the files to be retrieved from a central location to offer products remotely.

In an embodiment of the exemplary application, a full product catalog consists of the XML files shown in Table 1, which also provides a description of the purpose for the various files. It will be understood that the data contained in the files mentioned below may be combined so that fewer files are present.

TABLE 1

| Name | Purpose |
|---|---|
| FileManifest | The FileManifest xml is used to track sets of |
| | files that are defined as packages for download |
| | to the remote system. Each package may con- |
| | tain an execution command that fires after all |
| | files in the package have been received. |
| | When a local file is changed, the file manifest |
| | is updated to reflect the modification. The |
| | processes operating on this xml file are re- |
| | sponsible for transfer of files to/from the |
| | remote system and for updating the file when |
| | the files referenced have changed. |
| ProductConfig | The ProductConfig file will maps following the |
| | catalog item file, the fulfillment data file, and |
| | the pricing table file. The file also contains the |
| | listing of allowed shipping methods. |
| Item | The Item XML file is used to define the gen- |
| | eral aspects of an item such as it's ProductCode |
| | for ordering, print dimensions, and options |
| | available. The Item files are partitioned by |
| | items to reduce the impact of changes to a |
| | single item. |
| PricingTable | Similar to the Item XML, the PricingTable |
| | XML is partitioned into individual files that |
| | can be referenced by multiple Products. This |
| | allows for multiple products to share pricing. |
| | In the case of greeting cards, for example, |
| | there is no need to define pricing for every |
| | single greeting card item, it can be defined |
| | once and then referenced by the item for it's |
| | pricing. |
| Categories | The Categories XML defines the vendor de- |
| | fined categorization of items and the relation- |
| | ship between other categories. This file |
| | is not partitioned like the item and the pricing |
| | table xml files are. |
| ItemTypes | Each item is associated with a single item type |
| | based on the methods by which the product is |
| | edited or produced. The item type is deter- |
| | mined by the vendor and is not customizable |
| | per vendor. |
| PaymentMethods | The PaymentMethods file contains the defini- |
| | tions of the available payment methods for the |
| | consuming application. This includes the mini- |
| | mum and maximum currency amounts allowed |
| | per method as well as the shipping codes that |
| | they are allowed for. In the case that the pay- |
| | ment method is credit card, the file format |
| | supports listing of the types of card allowed. |
| PickupTimeBusinessRules | This file defines the business rules to determine |
| | product pickup/delivery times. |
| Promotions | The promotions file will define promotions |
| | available and the criteria for having an order |
| | promoted. |
| PromCodes | For promotions that require a promotion code |
| | to be entered, a PromCode file will be placed |
| | on the system. This will be updated when a |
| | promo code is claimed as well as be used to |
| | validate that the promotion code entered is |
| | allowed. |
| Template | The template xml file defines the components |
| | that make up the template including clip art, |
| | masks, and suggested inset locations. |
| StoreInfo | The store info xml file contains the store |
| | address, hours of operation, outlab delivery |
| | schedule, and tax rates. |
| PricingGroups | PricingGroups contains the definition of |
| | customer type information used to determine |
| | pricing extended to the customer. There needs |
| | to be a default pricing group defined and |
| | optionally other pricing groups, for example |
| | Photo Club members for customers that |
| | have purchased a membership from the retailer. |

The system and method of the present invention, importantly, provides a convention/set of rules for the structure, content and use of the tags in the product catalog, thereby providing an interrelationship among the several data items contained therein. This provision enables the design and implementation of an easily maintained system, for providing relevant product offerings from multiple fulfillment centers having varied capabilities, to individual customers and order centers. Even further, the provisions make the system flexible, scalable, and robust.

### Representative Implementation

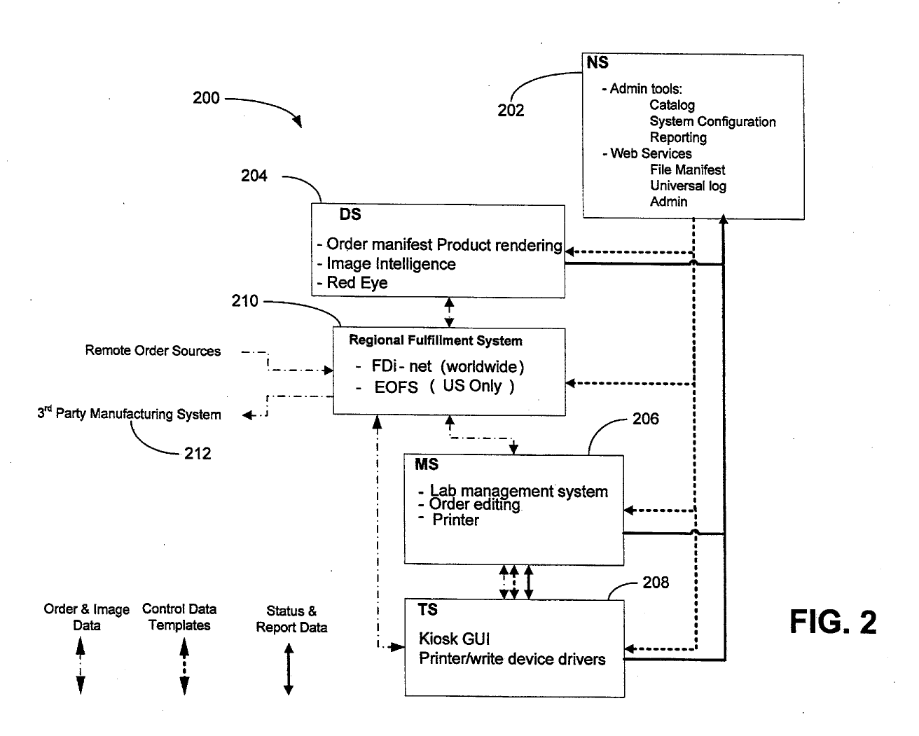

The present invention and the advantages thereof can be further appreciated by considering a representative implementation. The design and implementation of an exemplary system in accordance with the present invention is best described with reference to FIG. 2 and the illustrated system, designated as reference numeral 200. The system 200 is a suite of products that bring together a number of disparate systems and take advantage of a connected environment. More specifically, the system 200 is an asset tracking system utilized by a vendor in the photo processing industry. The vendor and its products or systems are required to interact with a number of organizational units both internally and externally. As would be expected, such endeavors traditionally involve a number of disparate systems and suites of applications. The vendor must deal with communication, configuration, deployment, reporting and production issues not just nationally but also internationally. To address these requirements, the system 200, utilizes the system and method of the present invention. The required functionality of the system 200 for providing the necessary interaction with a fulfillment system 210 is partitioned into essentially four components, namely NS 202, DS 204, MS 206 and TS 208. The system 200 eliminates the need for translations or gateways between suite components, increases the amount of code re-use and provides a unification of technologies across the components.

The first component NS 202, provides centralized management and reporting for all other systems, including product catalog editing, remote system configuration editing, and data collection for reporting. The second component DS 204, provides standard interfaces for orders from variety of sources such as kiosks, web sites and desktop applications, to manufacturing systems, such as MS 206 or 3^{rd} party fulfillment systems 212. The third component MS 206, provides scanning, printing and local TS 208 and MS 206 order management functions. The fourth component TS 208, is a Kiosk application with optional support for local output devices.

For the sake of brevity, only one of these components—NS 202, will be addressed in the discussions herein. NS 202, is the central configuration system for the other components, supplying catalog and configuration data, including templates, application software and settings. NS 202 also receives and stores messages containing production data for maintenance and reporting purposes. A web service is optionally provided for access to that data by other external applications, such as reporting tools. NS 202, is defined by a data model, wherein all configuration and installation data in NS 202 is maintained in a hierarchical structure.

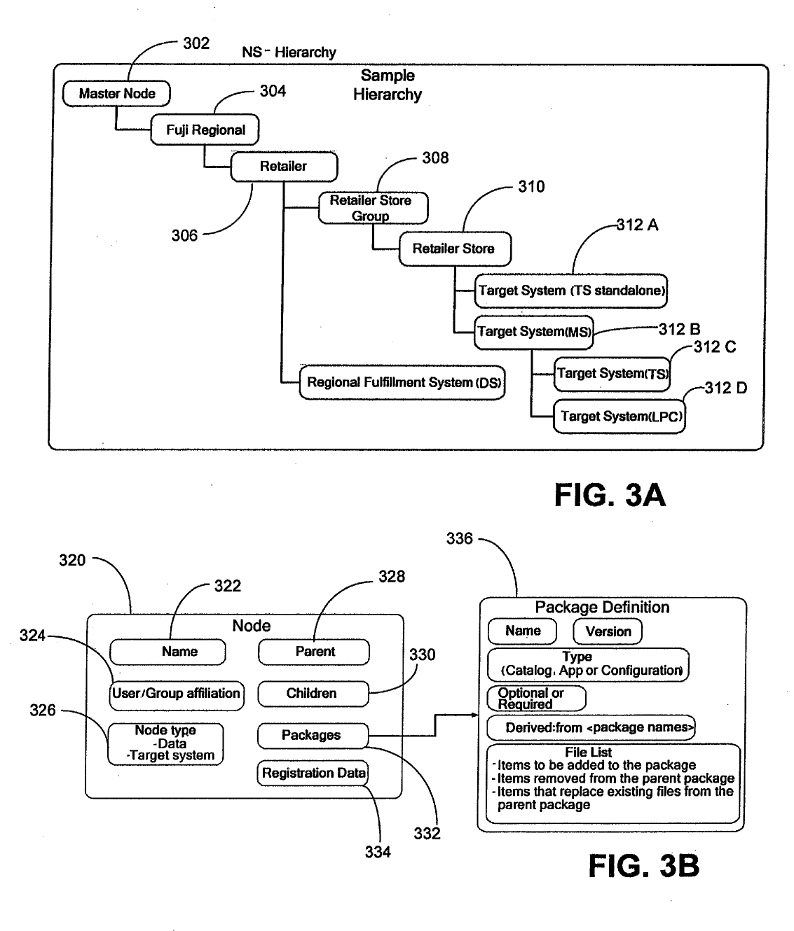

FIG. 3A illustrates the hierarchical structure 300, an aspect of the implementation of the present invention, applied to the NS 202 component. As shown, each node within the hierarchy represents a group of systems or child nodes. In this way, any number of levels may be used to represent the entire population of systems in the field of endeavor.

A node 320 is best described by the illustration of FIG. 3B. As shown, a node 320 may comprise a number of elements namely, a node name identification 322, a user/group affiliation 324, a node-type 326, a parent name 328, one or more child names 330, packages 332, and registration data 334. The field names of the components of the node 320 are self explanatory for the most part, with a few exceptions. The user/group affiliation 324 allows a node to be specifically tied to an organization unit or individual, who may for example be responsible for providing updates or otherwise have some unique access to the node's definitions. The node-type 326, identifies if the node 320 represents data or is part of an application related file. Because the node 320 is a member of a hierarchical group, each node 320 would have a parent and/or either zero, one or multiple children. That name or other identification of that parent/child node is provided to the appropriate element 328, 330. Each node 320 may contain any number of data sets called “packages” 332.

Packages 332 contain logical groups of files. A package definition 336 illustrates some of the information that is grouped therein. In the simplest case, a system node might just require two packages 332: one for the application software and installer, and another for the product catalog. Additional packages might be used for adding products, changing pricing, files for promotions, software patches, etc.

Node 320 may be used to describe, configure and implement the component NS 202 hierarchy displayed in FIG. 3A, namely, target systems 312A, 312B, 312C, 312D. These target systems may be deployed at any location for use by end users. A node 320 may be defined using other nodes. Turning to FIG. 3A and as shown in structure 300, a root or master node 302 may contain worldwide data, such as software releases. Below that may be a regional node 304 specified for each region. Below that may be a specific retailer node 306, a retailer store group node 308, a retailer store node 310, and individual target system nodes 312A, 312B, 312C, 312D.

Importantly, in one aspect of the present invention, data from each node 320 may be inherited by children of the node. As such, data may be deployed to multiple systems or groups of systems by simply altering the data contained in a parent node. So for example, if a particular retailer with multiple locations say in the western region or group, is offering a special or promotion, it would not be necessary to manually or otherwise touch or update each target system individually within that region. Instead, by applying such change, to the retailer store group node 308, all subsequent child nodes (i.e., retailer store node 310 and the target system nodes 312) will inherit that particular attribute, thus the promotion information is permeated to applications running on the relevant target systems.

In another aspect of the present invention, an asset exclusion concept, allows a derived tag or node to contain an optional list of assets that are found in ancestor tag asset sets but are to be excluded from an asset distribution of the derived tag.

In a further aspect, an asset replacement concept, enables a derived tag to specify that an asset present within the asset collection of its ancestor tags is to be replaced by another asset.

In yet another aspect, of the present invention, a tag resolution or “flattening” concept is provided. A set of assets for distribution is determined by evaluating a tag definition, including each of its ancestor tag definitions and also including the grouping criteria, asset references, asset exclusions and asset replacements defined in each. This process is referred to as “flattening” the tag, as it conceptually resolves the complex hierarchical relationships into a single listing of assets to be included in an asset distribution.

In an even further aspect, a tag type Concept is provided. Tags may be classified according to a Type property. Examples of the type property include “Code” or “Catalog” to differentiate tags meant to be included in a software distribution versus tags meant to be included in a photo product catalog distribution.

If a target system is acting as a proxy between additional systems and NS 202, then the corresponding nodes within the hierarchy represent both the target system and parent for all systems connected to it. This is the case where an MS system 206 is acting as a proxy server for one or more TS systems 208.

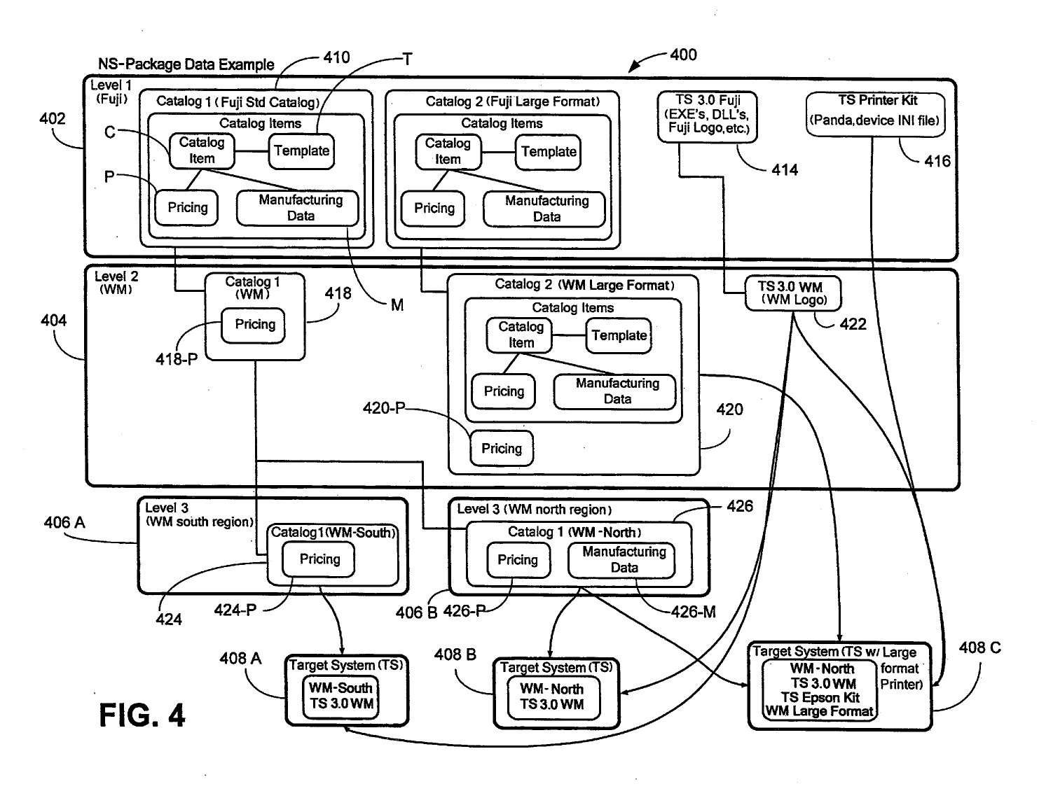

An implementation that utilizes the NS 202, is next described to further illustrate aspects of the present invention, with reference to FIG. 4 and generally referenced as system 400. As shown, system 400 is a four-level hierarchy containing vendor “Fuji” 402, Retail Store (WM) 404, two regions within Regional Retail Store (WM) 406A, 406B (collectively references as Regional Stores (WM) 406), and three target TS systems 408A, 408B, 408C (collectively referenced as TS systems or target systems 408).

There is one basic TS system 408A in each region, plus one TS system 408B that has a large format printer. Target systems 408 receive only the necessary packages by name. In this scenario and as can be deduced by from the system illustration 400, vendor Fuji at level 402, provides services, applications and systems to Retail Store (WM) at level 404. Retail Store (WM) has a number of regional offices or systems 406. The Regional Stores (WM) 406 in turn have individual stores or locations with target systems 408, that acquire end customer orders and process them accordingly. As previously described and as would be readily apparent, options available at these target systems 408 and the behavior of these target systems 408, is a function of requirements/specifications provided at each of the levels above (i.e. vendor Fuji 402, Retail Store (WM) 404, and Regional Stores (WM) 406.

In operation, vendor Fuji 402 may define a number of named tags corresponding to packages. This includes a number of catalogs—“Fuji std Catalog” 410, “Fuji Large Format” 412; application files—“TS 3.0 Fuji” 414; and asset/device information—“TS Printer Kit” 416. As illustrated, each of the catalogs 410, 412 may further include a number of items such as a specific catalog item C, a template T, pricing information P and manufacturing data M. The application “TS 3.0 Fuji” 414 may include executable files, dynamic link library files, a logo file, and other files that are necessary for the application. The device “TS Printer Kit” 416 may include device specific INI files and other related data.

At the next level of the hierarchy, Retail Store (WM) 404, is defined by catalogs “WM” 418, “WM Large Format” 420 and application “TS 3.0 WM” 422. Catalog “WM” 418 defines a new pricing 404-P tag. On the other hand, “WM Large Format” 420 defines an instance of catalog items C, P, T, M and a pricing tag 404-P. Application “TS 3.0 WM” 422 is defined as an instance of the application “TS 3.0 Fuji” 414.

Regional Store (WM) 406A is defined by catalog “WM-South” 424, inherited from catalog “WM” 418 and a new pricing tag 424-P. Regional Store (WM) 406B is defined by catalog “WM-North” 426 also inherited from “WM” 418 with a new pricing tag 426-P and a new “Manufacturing Data” tag 426-M.

Target systems 408 are identified by a series of named tags, or attributes, which correspond to package names from the upper levels of the hierarchy system 400. As previously described, each target system 408A, 408B, 408C is identified by a series of named tags, or attributes, which correspond to package names. In this way a system may be associated with multiple packages, such as shown above. To build a complete set of packages for a target system, each node starting from the root is recursively merged with its parent by overlaying modified data elements associated with a particular target system's attributes onto the accumulated package data. A child node can remove, alter, or append data received from further up the tree. Only packages specified for a particular target system are deployed to that system. Certain elements (e.g., pricing 424-P, 426-P, 418-P, 420-P) override elements from higher up in the hierarchy.

Each of the target systems 408 is accordingly identified as follows: Target System 408A =“WM-south” 424 +“TS 3.0 WM” 422 ; Target System 408B =“WM-North” 426 +“TS 3.0 WM” 422 ; and Target System 408C =“WM-North” 424 +“TS 3.0 WM” 422 +“TS Printer Kit” 416 +“WM Large Format” 420

Having described the system and method of the present invention and an embodiment thereof, an exemplary computer environment for implementing the described design and execution is presented next.

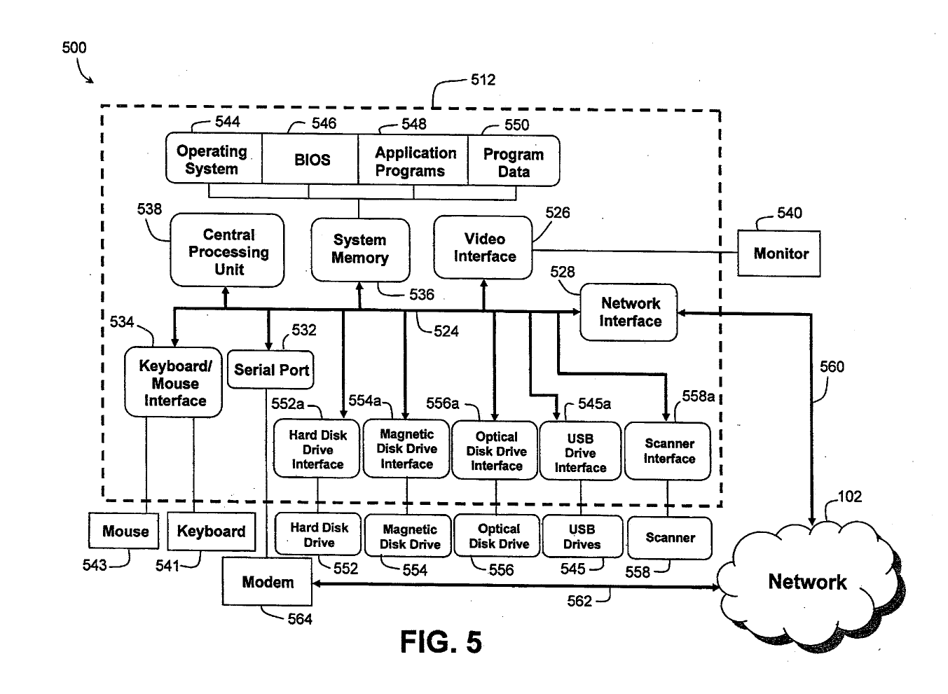

FIG. 5 shows an exemplary computing environment 500 that may be used to implement any of the processing thus far described. The computing environment 500 may comprise a computer 512 including a system bus 524 that couples a video interface 526, network interface 528, one or more serial ports 532, a keyboard/mouse interface 534, and a system memory 536 to a Central Processing Unit (CPU) 538. A monitor or display 540 is connected to bus 524 by video interface 526 and provides the user with a graphical user interface to view, edit, and prepare a print order data file using the digitally represented still images. The graphical user interface allows the user to enter commands and information into computer 512 using a keyboard 541 and a user interface selection device 543, such as a mouse or other pointing device. Keyboard 541 and user interface selection device are connected to bus 524 through keyboard/mouse interface 534. The display 540 and user interface selection device 543 are used in combination to form the graphical user interface which allows the user to implement at least a portion of the present invention. Other peripheral devices may be connected to computer 512 through serial port 532 or universal serial bus (USB) drives 545 to transfer information to and from computer 512. For example, cameras and camcorders may be connected to computer 512 through serial port 532 or USB drives 545 so that data representative of a digitally represented still image or video may be downloaded to system memory 536 or another memory storage device associated with computer 512 so that the images may be subsequently printed by fulfillment centers 112 in accordance with the present invention.

The system memory 536 is also connected to bus 524 and may include read only memory (ROM), random access memory (RAM), an operating system 544, a basic input/output system (BIOS) 546, application programs 548 and program data 550. The computer 512 may further include a hard disk drive 552 for reading from and writing to a hard disk, a magnetic disk drive 554 for reading from and writing to a removable magnetic disk (e.g., floppy disk), and an optical disk drive 56 for reading from and writing to a removable optical disk (e.g., CD ROM or other optical media). The computer 512 may also include USB drives 545 and other types of drives for reading from and writing to flash memory devices (e.g., compact flash, memory stick/PRO and DUO, SD card, multimedia card, smart media xD card), and a scanner 550 for scanning items such as still image photographs to be downloaded to computer 512. A hard disk interface 552a, magnetic disk drive interface 554a, a optical drive interface 556a, a USB drive interface 545a, and a scanner interface 558a operate to connect bus 524 to hard disk drive 552, magnetic disk drive 554, optical disk drive 556, USB drive 545 and a scanner 558, respectively. Each of these drive components and their associated computer-readable media may provide computer 512 with non-volatile storage of computer-readable instruction, program modules, data structures, application programs, an operating system, and other data for the computer 512. In addition, it will be understood that computer 512 may also utilize other types of computer-readable media in addition to those types set forth herein, such as digital video disks, random access memory, read only memory, other types of flash memory cards, magnetic cassettes, and the like.

Computer 512 may operate in a networked environment using logical connections with fulfillment centers 112. Network interface 528 provides a communication path 560 between bus 524 and network 520, which allows a print order data file to be communicated through network 520 to fulfillment centers 112 after the print order data file has been established, and optionally saved in a memory, using computer 512. This type of logical network connection is commonly used in conjunction with a local area network (LAN). The print order data file may also be communicated from bus 524 through a communication path 562 to network 520 using serial port 532 and a modem 564. Using a modem connection between the computer 512 and photofinisher 108 is commonly used in conjunction with a wide area network (WAN). It will be appreciated that the network connections shown herein are merely exemplary, and it is within the scope of the present invention to use other types of network connections between computer 512 and fulfillment centers 112 including both wired and wireless connections.

From the foregoing, it will be seen that this invention is one well adapted to attain all the ends and objects hereinabove set forth together with other advantages which are obvious and which are inherent to the method and apparatus. It will be understood that certain features and sub combinations are of utility and may be employed without reference to other features and sub combinations. This is contemplated by and is within the scope of the claims. Since many possible embodiments of the invention may be made without departing from the scope thereof, it is also to be understood that all matters herein set forth or shown in the accompanying drawings are to be interpreted as illustrative and not limiting.

The constructions described above and illustrated in the drawings are presented by way of example only and are not intended to limit the concepts and principles of the present invention. As used herein, the terms “having” and/or “including” and other terms of inclusion are terms indicative of inclusion rather than requirement.

While the invention has been described with reference to preferred embodiments, it will be understood by those skilled in the art that various changes may be made and equivalents may be substituted for elements thereof to adapt to particular situations without departing from the scope of the invention. Therefore, it is intended that the invention not be limited to the particular embodiments disclosed as the best mode contemplated for carrying out this invention, but that the invention will include all embodiments falling within the scope and spirit of the appended claims.

What is claimed is:

1. A method for providing one or more product offerings on a target system, comprising
applying grouping criterion to one or more assets to define a first tag having one or more content items, wherein each asset is a version or reference to a data file;
utilizing said first tag to subsequently define and describe a second tag, wherein said second tag inherits said one or more content items from said first tag, said second tag being defined to include one or more additional content items including assets, grouping criteria and version;
providing a hierarchical relationship between said first and second tags, whereby said second tag operates to modify or remove one or more content items inherited from said first tag; and
defining a catalog item utilizing said first and/or second tag, wherein said catalog item is mapped to said one or more product offerings on said target system.

2. A computing system for managing a plurality of data files and the interrelationship among the plurality of data files in a business enterprise deployment of an application or product, the computing system having executable instructions and data structures, comprising:
a hierarchical data model for specifying the configuration of said application or product as a grouping of one or more tags;
said one or more tags comprising;
one or more assets each providing a reference to said data files;
a grouping criteria for providing common properties among said assets; and
a tag version;
wherein said one or more tags is a binding of said one or more assets defined by said grouping criteria;
wherein said tag version is a reference to a particular representation in time of said one or more assets and said grouping criteria;
wherein said one or more tags are associated with organizational units in said business enterprise;
wherein said hierarchical data model is resolved to determine each of said plurality of data files to be included in the enterprise deployment.

3. The system of claim 2, wherein said one or more tags further comprise a type property, wherein said type property differentiates tags to be included one distribution type over another distribution type.

4. The system of claim 3, wherein a first distribution type is a software distribution and a second distribution type is a product catalog distribution.

5. The system of claim 2, wherein a derived second tag is specified and inherits from an ancestor one of said one or more tags and thereby includes the assets, grouping criteria and version of said ancestor tag, and wherein said derived second tag may further include a separate set of assets, grouping criteria and version.

6. The system of claim 5, wherein said hierarchical data model provides an asset replacement feature, wherein said derived second tag may specify the replacement of an asset found in an asset collection of said ancestor tag with a different asset.

7. The system of claim 5, wherein said hierarchical data model provides an asset exclusion feature, wherein said derived second tag contains an option list of assets inherited from ancestor tags, which are to be excluded from an asset distribution of said derived second tag.

8. A method programmed in a computing environment for providing packaging, tracking and maintenance of a logical grouping of system files for distribution to organizational units within an enterprise, the method comprising:
identifying each of said system files as assets;
providing a grouping criterion of common properties among said assets;
providing a tag, wherein said tag is a binding of said assets by said grouping criterion;
providing a version designation for said tag to refer to a snapshot of the state of the assets associated with said tag at a certain point in time;
providing a hierarchical data model for specifying the configuration of said distribution as a grouping of two or more of said tag; and
associating said tag with organizational units within said enterprise;
wherein resolution of said hierarchical data model identifies each system file that is to be included in said enterprise distribution for each of the organizational units.

9. The method of claim 8, wherein said grouping criterion is a common property among said assets including at least one of the manufacturer or model of a printer device to which the assets pertain.

10. The method of claim 8 further comprising providing a type property for designating or identifying a particular distribution for said tags, wherein said type property differentiates tags to be included one distribution over another distribution.

11. The method of claim 8, wherein a second tag is derived from an ancestor tag and thereby includes the assets, grouping criteria and version of said ancestor tag, and wherein said derived second tag may further include a separate set of assets, grouping criteria and version.

12. The method of claim 11 further comprising providing an asset replacement feature, whereby said derived second tag may specify the replacement of an asset found in an asset collection of said ancestor tag with another asset.

13. The method of claim 11 further comprising providing asset exclusion feature, wherein said derived second tag contains an option list of assets inherited from ancestor tags, which are to be excluded from an asset distribution of said derived second tag.
